(19) United States
(12) Patent Application Publication
(10) Pub. No.: US 2025/0262671 A1
(43) Pub. Date: Aug. 21, 2025

(54) Calibration system and calibration method for calibrating a building platform system in an additive manufacturing device

(71) Applicant: Additivestream4d GmbH, Berlin (DE)

(72) Inventors: Simon Frederik Feicks, Berlin (DE); Clemens Cosmo Miaskowski, Berlin (DE)

(21) Appl. No.: 18/848,192

(22) PCT Filed: Nov. 1, 2023
(86) PCT No.: PCT/DE2023/150028

§ 371 Date: Sep. 18, 2024

(30) Foreign Application Priority Data
Nov. 3, 2022 (DE) 10 2022 129 035.2

(51) Int. Cl. B22F 10/31; B22F 12/30; B22F 12/90

(52) U.S. Cl. CPC B22F 10/31; B22F 12/30; B22F 12/90

(57) ABSTRACT

A calibration system and calibration method for calibrating a building platform system arranged in a building space of a laser-based additive manufacturing device. The calibration system comprises a calibration plate, which can be fixed on the building platform system, and an optics module. A calibration pattern, which is captured in the form of an image by an optical capturing unit, is applied in the calibration plate, which consists of a base metal material and is provided with a surface layer with a color which contrasts that of the base metal material, in order to calibrate the building platform system. By analyzing the image, correction values are determined which are used to calibrate the building platform system and the additive manufacturing device. Preferred areas of use for the calibration system and the calibration method include hybrid additive manufacturing of new parts and the repair of conventionally or additively manufactured components.

### CROSS REFERENCE TO RELATED APPLICATIONS

This application is the U.S. national stage of International Application No. PCT/DE2023/150028, filed on 2023 Nov. 1. The international application claims the priority of DE 102022129035.2 filed on 2022 Nov. 3; all applications are incorporated by reference herein in their entirety.

### BACKGROUND

The invention relates to a calibration system and a calibration method for calibrating a building platform system arranged in a building space of a laser-based additive manufacturing device. Preferred areas of use of the calibration system and the calibration method are hybrid additive manufacturing of new parts and the repair of conventionally or additively manufactured components.

Additive manufacturing processes, such as powder bed-based selective laser melting (Laser Powder Bed Fusion, LPBF), are primarily designed for the near-net-shape production of completely new parts: Based on a virtual 3D component model, material is consolidated layer by layer on a building platform of the additive manufacturing device until the component body specified by the 3D model is completed. The starting material for the production of high-quality, metallic components using powder bed-based selective laser melting is usually a narrowly specified and therefore cost-intensive metal powder, which, however, is only melted to a fraction to form the additively manufactured component. A large part of the powder serves only as filler and support material.

The additive manufacturing of metallic components using selective laser melting is still sometimes unprofitable compared to traditional manufacturing processes in many industries due to long production times, insufficiently known material data and also due to the high powder consumption. However, additive manufacturing has already established itself in the production of high-priced, geometrically complex or customized components, especially components from the aviation industry or medical technology.

In addition to the production of new parts, additive manufacturing also offers the possibility of repairing components close to their final shape. In the aircraft engine industry, for example, parts of blades or vanes are repaired by additively building up the worn material.

Additive manufacturing, in which material is applied to existing components or component elements close to the final shape, is also referred to as hybrid (additive) manufacturing. In contrast to complete manufacturing, hybrid manufacturing requires precise positioning of the components within the manufacturing device or exact knowledge of the component position on the building platform.

The building platform is generally the part of the additive manufacturing device on which the components are manufactured. In the context of this disclosure, the entirety of all device parts of the additive manufacturing device that support the components to be manufactured is referred to as the building platform system. The building platform in the narrower sense is understood to be the device element, usually in the form of a plate, on which the additively manufactured components are directly attached. The building platform system therefore comprises at least the building platform. In the simplest structural design, the building platform system is limited to the building platform.

In hybrid additive manufacturing of a component, material is applied to an existing body, hereinafter referred to as the base body, by additive built-up. The additively built-up part of the component, the build-up body, forms the component together with the base body after additive manufacturing has been completed.

With regard to laser-based additive manufacturing processes, such as powder bed-based selective laser melting, the challenge in hybrid additive manufacturing is that the laser (more precisely the laser scanner) is controlled in a separate coordinate system, the laser coordinate system. The geometry data of the building platform system and that of any base molded bodies present on it are transferred to the laser control unit before the additive manufacturing process begins, i.e. transferred to the laser coordinate system. After the data transfer, the laser coordinate system is independent of the coordinate system used to define the actual position of the building platform system and the position of the basic bodies already present on the building platform system in the building space. The latter coordinate system is referred to as the building space coordinate system. If a base body is located at a certain position in the building space, the laser (or the laser spot) does not always hit the base body with sufficient accuracy in hybrid additive manufacturing. For each position of the objects in the building space that can be defined by building space coordinates in the building space coordinate system, a deviation, also called an offset, can occur between the building space coordinates in the building space coordinate system and the laser coordinates in the laser coordinate system.

In order to achieve high-precision control of the laser and thus ultimately ensure high accuracy in hybrid additive manufacturing, the building space coordinates can be corrected with a correction value and this corrected position information of the building platform system and the base body can be transferred to the laser coordinate system.

The correction values for the building space coordinates can in turn be determined by a calibration carried out within the additive manufacturing device. Calibration methods used for this purpose are regularly based on the photographic image capture of patterns and reference markings. Such calibration methods and the calibration devices or calibration systems used for them are known from EP 0 792 481 B1, DE 199 18 631 A1, U.S. Pat. No. 6,483,596 B1, WO 2017/158327 A1 or DE 10 2021 105 918 A1, among others.

WO 2017/158327 A1 describes a calibration method in which a calibration pattern is introduced into an aluminum plate using the laser of the additive manufacturing device.

EP 4 151 342 A1 further discloses a manufacturing system for the additive manufacturing of a workpiece, wherein the manufacturing system comprises, among other things, a building plate and an optical device for capturing image data of the building plate. WO 2020/212 108 A1 describes a calibration method for a camera intended for monitoring an additive manufacturing process, wherein an additively manufactured component is compared with a sample of this component to calibrate the camera.

These known calibration procedures and the calibration devices or calibration systems used for them regularly focus on classic additive manufacturing, i.e. the production of completely new parts, or involve intervention in the machine control system.

### SUMMARY

The invention relates to calibration system and to a calibration method for calibrating a building platform system (1) arranged in a building space (2) of a laser-based additive manufacturing device. The calibration system comprises a calibration plate (5), which can be fixed on the building platform system (1), and an optics module (4). A calibration pattern (6), which is captured in the form of an image by an optical capturing unit (4.1), is applied in the calibration plate (5), which consists of a base metal material and is provided with a surface layer with a color which contrasts that of the base metal material, in order to calibrate the building platform system (1). By analyzing the image, correction values are determined which are used to calibrate the building platform system (1) and the additive manufacturing device. Preferred areas of use for the calibration system and the calibration method include hybrid additive manufacturing of new parts and the repair of conventionally or additively manufactured components (3).

### DETAILED DESCRIPTION

The object of the invention is to provide a calibration system and a calibration method for calibrating a building platform system arranged in a building space of an additive manufacturing device, which enables the precise material build-up in laser-based hybrid additive manufacturing of components without the need for intervention in the machine control.

This object is achieved by a calibration system with the features of claim 1 and a calibration method according to claim 8. Further embodiments of the invention are described in claims 2 to 7 and 9 to 11.

The calibration system described below and the calibration method carried out with it are used to calibrate a building platform system arranged in a building space of an additive manufacturing device, wherein the additive manufacturing device has a controllable laser for consolidating material during additive manufacturing on the building platform system. In common additive manufacturing devices, such as systems for powder bed-based selective laser melting, the building space is located in a building pit in which the building platform system is also usually installed in a height-adjustable manner.

In such laser-based additive manufacturing of components on a building platform system of an additive manufacturing device, the position of the building platform system in the building space, like all other objects in the building space, is defined by building space coordinates within a building space coordinate system. In hybrid additive manufacturing of a component from a base body and a built-up body additively built on top of the base body, the position of the base bodies is also described by these building space coordinates within the building space coordinate system. Before additive manufacturing begins, the building space coordinates are transferred to a control unit of the additive manufacturing device intended to control the laser.

The calibration of the building platform system described below is based on the fact that the known building space coordinates intended for controlling the laser, generated for example from computer models or from preliminary measurements outside the manufacturing device, are transferred to the control unit of the additive manufacturing device together with a correction value or correction factor for each individual building space coordinate so that the laser can accurately hit the intended actual position within the building space.

The determination of these correction values is therefore the narrower aim of the calibration procedure described below and the calibration system used for this purpose.

According to the invention, the proposed calibration system comprises an optics module and a calibration plate which can be fixed on the building platform system and consists of a predetermined, preferably metallic base material.

The optics module comprises an optical detection unit, an optics holder and a support plate for covering the building space of the additive manufacturing device. The support plate has a light passage recess, in the area of which the optical detection unit is attached by means of the optics holder so that the calibration plate placed in the building space can be optically detected. The optical detection unit is usually located on the side of the support plate opposite the building space. The optical axis of the optical detection unit is preferably aligned perpendicular to the support plate. The optical detection unit can be, for example, a camera or a (preferably high-resolution) structured light projection unit.

On the building space side, lighting devices for illuminating the building space are attached to the support plate, for example in the form of light-emitting diodes, which are preferably evenly distributed on the building space side of the support plate.

The calibration plate has a visible surface on one of its two flat sides, which faces the optical detection unit when the calibration system is set up as intended. The visible surface of the calibration plate is provided with a surface layer that contrasts with the specified base material in terms of color, i.e. the surface layer has a clear color contrast to the color of the specified base material. The surface layer is preferably dark, for example black, while the uncoated base material has a bright appearance (often a silvery-metallic appearance in the case of a metallic base material).

The calibration system can also comprise one or more reference mark carriers, each with a reference marking. These reference mark carriers can be fixed in a precise position on the building platform system. They serve as reference points on the building platform system fixed in the additive manufacturing device. To ensure that the optical detection unit can see the reference markings, reference mark recesses can be made in the calibration plate.

The calibration method according to the invention for calibrating the building platform system that is properly secured in the building space of the laser-based additive manufacturing device is carried out with the calibration system described above, which comprises the optics module, the calibration plate and the reference mark carriers having the reference markings, and with an evaluation unit for evaluating position parameters and for determining the above-mentioned correction values.

To calibrate the building platform system, the calibration plate and the reference mark carriers are fixed in such a way that the visible surface and the reference markings are visible simultaneously when looking at the visible surface of the calibration plate from above.

On the visible side of the calibration plate, a two-dimensional calibration pattern consisting of two-dimensional pattern elements is created in the visible surface plane of the calibration plate using the laser of the additive manufacturing device. The position of the individual pattern elements is defined by target position parameters that are stored in a computer model and transferred to the control unit of the additive manufacturing device in the form of the building space coordinates. The calibration pattern is manufactured on the basis of the target position parameters, which is then captured in the form of actual position parameters. The evaluation unit is set up to determine the correction values for the building space coordinates based on a target-actual comparison of the predetermined target position parameters and the captured actual position parameters, under consideration and in relation to the reference markings attached to the building platform system. The mathematical methods for determining the correction values from the two-dimensional target-actual pattern comparison are basically known and will not be explained further here.

According to the invention, the calibration process is carried out in the following process steps:
In the first step, the calibration plate and the reference mark carrier or carriers comprising the reference markings are fixed to the building platform system arranged in the building space of the additive manufacturing device. For this purpose, the building platform system is in turn installed as intended in the additive manufacturing device.
In the next step, the calibration pattern consisting of the pattern elements is applied on the visible surface of the calibration plate using the controllable laser by locally removing the surface layer. The calibration pattern extends over the entire visible surface of the calibration plate. The local removal creates a surface in the area of the pattern elements that differs in color from the surrounding surface layer. A bright pattern element in a dark environment has proven to be particularly suitable. When applying the calibration pattern into the calibration plate, the laser is preferably operated with the process parameters typical for additive manufacturing in the additive manufacturing device.
In the next step, the building platform system with the calibration plate attached to it is brought to a specified position in the building space, i.e. to a predetermined working distance from the optical detection unit, for example by lowering it in the building pit of the additive manufacturing system.
In the next step, the optics module is attached to the building space, with the support plate of the optics module covering the building space. The support plate is preferably dimensioned in such a way that the building space is completely shielded against the incident of ambient light by a slight oversize of the support plate.

In this position, a (preferably digital) image of the calibration plate is captured using the optical detection unit. The image can be, for example, a photograph or a point cloud. The optical detection unit is preferably aligned with its optical axis perpendicular to the calibration plate in order to capture a perspective-undistorted image of the calibration plate.

The captured image of the calibration plate is finally evaluated in the evaluation unit, i.e. the actual position parameters are determined for each individual pattern element of the calibration pattern. On this basis, the correction values of the building space coordinates are then also determined using the evaluation unit.

One of the advantages of the calibration system according to the invention and the calibration method is the use of the calibration plate with the surface layer, which is locally removed with the laser to apply the calibration pattern. This removal requires a setting of laser parameters, for example the laser power, which are relatively close to those used in the additive manufacturing of components.

This form of producing the calibration pattern means that all device-related deviations are precisely reflected in the captured image of the calibration pattern. Very precise spatially resolved correction values can be determined for each position of the building platform system. Since the building space coordinates with the correction values are transferred to the control unit for controlling the laser, no intervention in the control system is required, i.e. there is no intervention in the machine control of the additive manufacturing system. This is particularly important if the additive manufacturing device is subject to certification requirements. Since there is no need to intervene in the machine control of the additive manufacturing device when using the calibration method described here, system certifications are retained.

Another advantage of the compact design of the optics module with the support plate is that no external light falls into the building space during image capturing. The calibration plate is always illuminated in a consistent manner by the predefined lighting means attached to the support plate on the building space side during image capturing.

Calibrating the building platform system in an additive manufacturing device using the calibration method described above can be done quickly and easily. The calibration process usually takes only a few minutes.

Due to the improved manufacturing accuracy in additive manufacturing through calibration, the calibration system and the calibration method are particularly suitable for reducing costs in hybrid additive new part manufacturing, in repairing additively designed components, in repairing conventionally manufactured components or in repairing additively manufactured components after so-called “failed build jobs”, i.e. for correcting a defective additive structure.

The building platform system is preferably designed as described in the German patent application DE 10 2022 129 035.2 or in the international patent application with the application number PCT/DE2023/150027. In this regard, reference is made to the German patent application with the application number DE 10 2022 129 035.2 and the international patent application with the application number PCT/DE2023/150027, the contents of which are hereby incorporated into this patent application.

According to one embodiment of the calibration system, the base material from which the calibration plate is made is a material that corresponds to that of the components to be additively manufactured or is particularly similar to it in terms of manufacturing parameters. This is usually a metallic base material. It has been found, for example, that steel materials can be used relatively universally in this respect; in general, metallic materials with a density in the range of 4 g·cm⁻³ bis 10 g cm⁻³ are preferred as the base material of the calibration plate.

To improve contrast, the surface layer on the visible surface of the calibration plate has a matt appearance if possible. The surface layer can be a plating or a conversion layer, i.e. a surface layer produced by superficial conversion of the base material. The surface layer is preferably an oxidic conversion layer made of the base material of the calibration plate, in particular a metallic base material, for example a burnishing layer if the base material is a steel material, or an anodizing layer if the base material is a titanium or aluminum material. The oxidic conversion layers offer very good adhesion, i.e. are abrasion-resistant, usually have a matt appearance and, if they are not already dark in color, can be colored in a suitable manner.

Beside metallic materials, glass materials can also be used as the base material of the calibration plate.

According to a further embodiment, the optics module of the calibration system has one or more sensors. Such a sensor can, for example, be a distance sensor for detecting the distance between the calibration plate fixed on the building platform system and the optical detection unit attached to the building space. Suitable distance sensors include inductively operating distance sensors or laser-based distance sensors. The distance sensor makes it possible to precisely set or readjust the predetermined working distance of the optical detection unit.

Furthermore, the optics module can have an inclination sensor for determining the alignment of the optical detection unit and/or for monitoring the vertical alignment of the optical detection unit. The inclination sensor ensures that the optical detection unit in the optics module is aligned without tilting (vertically). The calibration plate and/or the underlying building platform system can also be equipped with an inclination sensor to check or ensure the vertical alignment of the optical axis of the optical detection unit to the calibration plate. If tilting is detected, this can be mathematically compensated or corrected subsequently as part of the evaluation.

Alternatively, tilting can also be checked using several of the distance sensors, which, for example, determine the distance between the optics module and the calibration plate at three or four positions.

A temperature sensor can also be installed in the optics module. The temperature sensor can be used to check whether a predetermined measuring temperature or a predetermined measuring temperature range is maintained for the optical detection unit and the calibration plate.

The optics module can also have an RFID transponder for contactless data storage and data query of identification data. The abbreviation RFID (radio-frequency identification) describes a well-known technology for the automatic and contactless identification and localization of objects using radio waves. An RFID system usually includes an RFID transponder and a reader. Access to the calibration system can be controlled using the RFID transponder of the optics module, for example by authorizing the release of the calibration system by the operator.

In larger additive manufacturing systems, for example those that have several lasers, i.e. so-called multi-laser systems, it can be provided that the optics module has several of the optical detection units, with each of the lasers being assigned one of the optical detection units. This allows the calibration to be carried out simultaneously for the respective processing field of each specific laser. According to another embodiment of the optics module, it can have a movable, for example a position-adjustable, optical detection unit. For this purpose, the optical detection unit is moved to defined positions in order to capture images for the respective processing field of each specific laser one after the other.

The reference mark carriers of the calibration system can be designed in different ways, for example as dowel pins that can be inserted in a fixed position in the building platform system. In order to avoid perspective errors when taking the image, the reference mark carriers are preferably attached to the building platform system in such a way that their reference marking is in the same plane as the visible surface of the calibration plate.

Preferably, a plurality of evenly distributed reference mark carriers or reference markings are attached to the building platform system, for example four on the corners and one reference marking arranged in the middle of a rectangle. Using the reference markings, a possible tilting of the optical detection unit relative to the calibration plate can be mathematically compensated. Here, a homography matrix is determined using the defined, known reference markings. On this basis, a “non-tilted” image can be calculated by multiplying each point of the image by the homography matrix.

As an alternative to dowel pins, any other form of reference mark carrier can be used that can be fixed in a defined manner to the building platform system, such as magnetic hemispheres.

The calibration plate can be fixed to the building platform system using screw connections, for example. Alternatively, magnetic holders can be used, the main advantage of which is that there is no loss of area on the visible surface due to the fastening elements, which means that more space is available for the pattern elements of the calibration pattern.

According to an embodiment, the calibration system can have a calibration platform for fixing the calibration plate to the building platform system, with the calibration plate being fastened to the calibration platform. The unit comprising the calibration plate and calibration platform is attached to the building platform system for calibration. The reference mark carriers are installed in a precise position on the calibration platform. To calibrate the building platform system, the calibration plate and the reference mark carriers are fastened or can be fixed to the building platform system via the calibration platform, i.e. indirectly.

According to one embodiment of the calibration method, the calibration pattern applied in the surface layer on the visible surface of the calibration plate by means of the laser consists of a large number of individual pattern elements, each of which has an identical, two-dimensional geometry. The pattern elements are placed at a distance from one another in rows and columns on the visible surface of the calibration plate. The pattern elements are preferably arranged in such a way that each of the pattern elements has a minimum distance from each of its neighboring pattern elements within the same row or column, which is greater than or equal to the extent or the extension of the pattern element.

Each of the pattern elements preferably has a fourfold rotational symmetry, at least two straight line segments perpendicular to each other and a single circle or point element. An example of such a design of the pattern element is a crosshair made up of two straight lines segments that cross in the middle and are perpendicular to each other, the intersection of which simultaneously forms the individual point element. Another design of the pattern element is a square with an inscribed circular element. Due to the fourfold rotational symmetry, the individual circular or point element is necessarily always located in the center of the pattern element. Using the circle or point element, the position coordinates or position in the plane of the pattern elements are determined as part of the position parameters. Using the line segments, an angular rotation is determined as part of the position parameters. For predetermined target position parameters for a specific pattern element of the calibration pattern, defined for example in the form of a target X position coordinate, a target Y position coordinate and a target angular position, an actual X position coordinate, an actual Y position coordinate and an actual angular position result after evaluation of the image of the calibration pattern for this pattern element. From the differences, i.e. by comparing the target and actual position parameters, the correction values for each of the building space coordinates in the building space coordinate system are determined using the evaluation unit.

### BRIEF DESCRIPTION OF THE DRAWINGS

The invention is explained in more detail below using exemplary embodiments and with reference to the schematic drawings, in which identical or similar features are provided with identical reference numerals. It shows:

FIG. 1: a building platform system equipped with components in perspective view,

FIG. 2: the calibration system installed in an additive manufacturing device according to a first embodiment in perspective view,

FIG. 3: the calibration system according to the first embodiment before applying the calibration pattern in perspective view,

FIG. 4: the calibration system according to the first embodiment after application of the calibration pattern in perspective view,

FIG. 5: the calibration plate with calibration pattern in top view,

FIG. 6: a target-actual comparison of the position parameters using a pattern element,

FIG. 7: the calibration system according to a second embodiment in perspective view,

FIG. 8: the calibration system according to the second embodiment in perspective view,

FIG. 9: details of the calibration system according to the second embodiment in perspective view and

FIG. 10: details of the calibration system according to the second embodiment in exploded view.

### DETAILED DESCRIPTION OF THE PREFERRED EMBODIMENTS

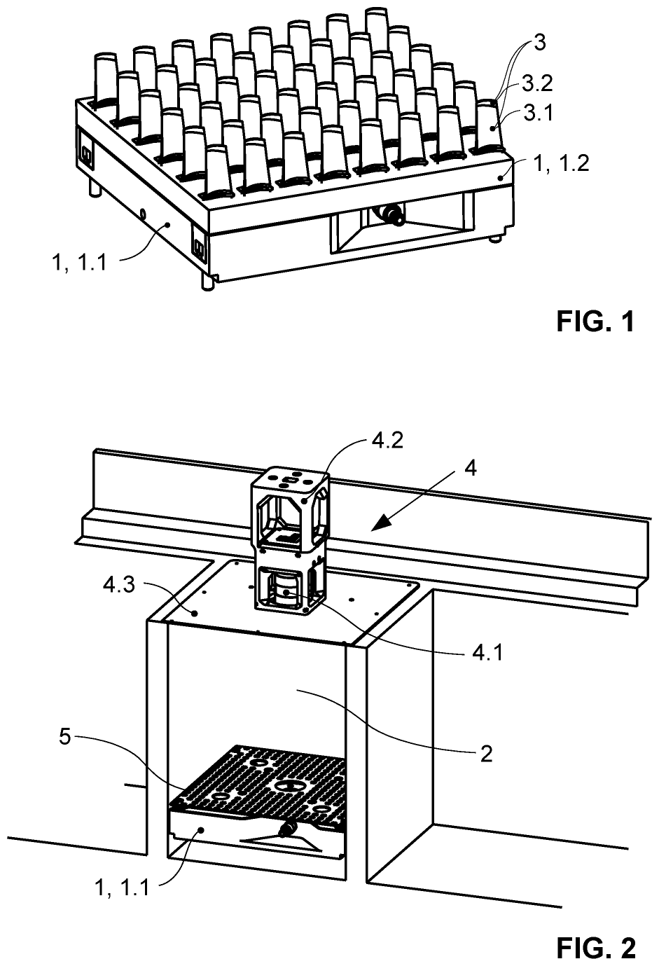

According to the embodiment of FIG. 1 the building platform system 1 to be calibrated consists of a machine interface unit 1.1 and a building platform 1.2 that can be precisely fixed to it, which in turn carries the components 3. FIG. 1 shows 48 components 3 manufactured by hybrid additive manufacturing, here turbine blades for aircraft engines as an example. During hybrid additive manufacturing, the build-up body 3.2, here the blade tip of the turbine blade, is additively built onto the base body 3.1 of the components 3, so that a complete component 3 is created from the base body 3.1 and the build-up body 3.2. Since the base bodies 3.1 are anchored in a fixed position on the building platform 1.2 before manufacturing starts and this in turn is locked in a fixed position on the machine interface unit 1.1, it is only necessary for this building platform system 1 to calibrate the machine interface unit 1.1.

With regard to the building platform system 1 shown in the embodiment, in particular its specific design, reference is also made to the international patent application PCT/DE2023/150027, the content of which is to be considered as part of the present disclosure.

The additive manufacturing device shown in FIG. 2 has a building pit, the interior of which is the building space 2. The building platform system 1 in the form of the machine interface unit 1.1 with the calibration plate 5 attached to it is brought into the building space 2.

The optics module 4 is installed on the building pit, with the support plate 4.3 sitting on top of the building pit walls so that no ambient light penetrates into the building space 2 during the recording of the image (here a photograph) of the calibration plate 5. The optical detection unit 4.1 used for image recording, here a camera, is attached to the support plate 4.3 by means of the optics holder 4.2 in such a way that the optical axis or viewing direction of the optical detection unit 4.1 is aligned perpendicular to the support plate 4.3. When the optics module 4 is installed as intended, the optical axis of the optical detection unit 4.1 is directed perpendicularly into the building space 2 of the additive manufacturing device and perpendicularly onto the calibration plate 5.

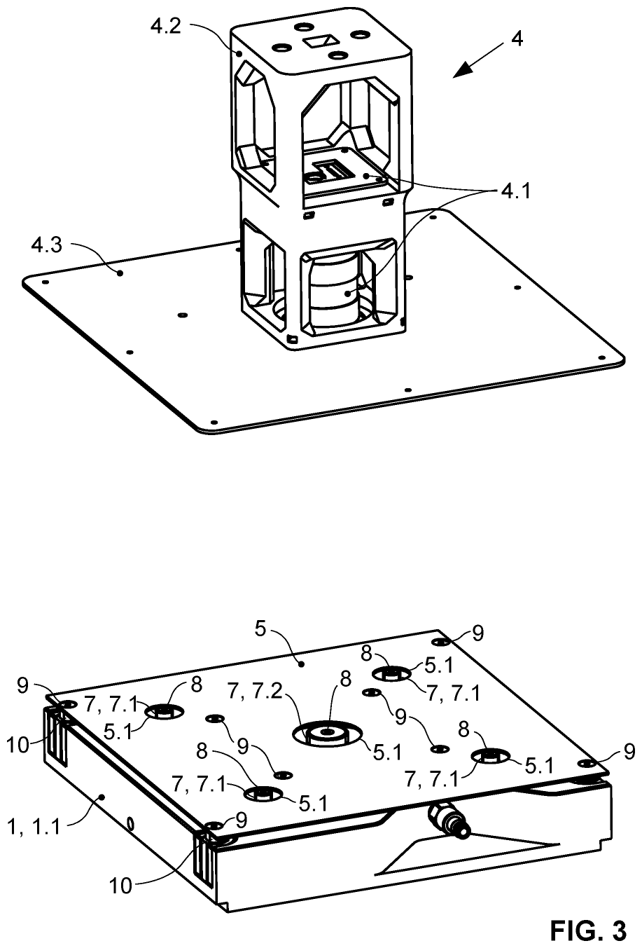

FIG. 3 shows a first embodiment of the calibration system for calibrating the building platform system 1 in the form of the machine interface unit 1.1 in detailed design.

The support plate 4.3 has light-emitting diodes on its (not visible) underside for illuminating the calibration plate 5. The optical detection unit 4.1 of the optics module 4 is fastened above the (not marked) light passage recess of the support plate 4.3 by means of the optics holder 4.2.

The calibration plate 5 fixed to the machine interface unit 1.1 in FIG. 3 before the application of the calibration pattern 6 has five reference mark recesses 5.1, which allow the optical detection unit 4.1 to see the reference markings 8 attached centrally to the front sides of the reference mark carriers 7. According to the embodiment, the reference mark carriers 7 are designed as calibration dowel pins 7.1 fitted in the machine interface unit 1.1 or as a hemispherical element 7.2 that can be magnetically fixed in the machine interface unit 1.1.

The calibration plate 5 is fastened to the machine interface unit 1.1 by means of the fastening screws 9, wherein the spacers 10 are inserted between the calibration plate 5 and the machine interface unit 1.1, which ensure that the reference markings 8 are in the same plane as the visible surface of the calibration plate 5.

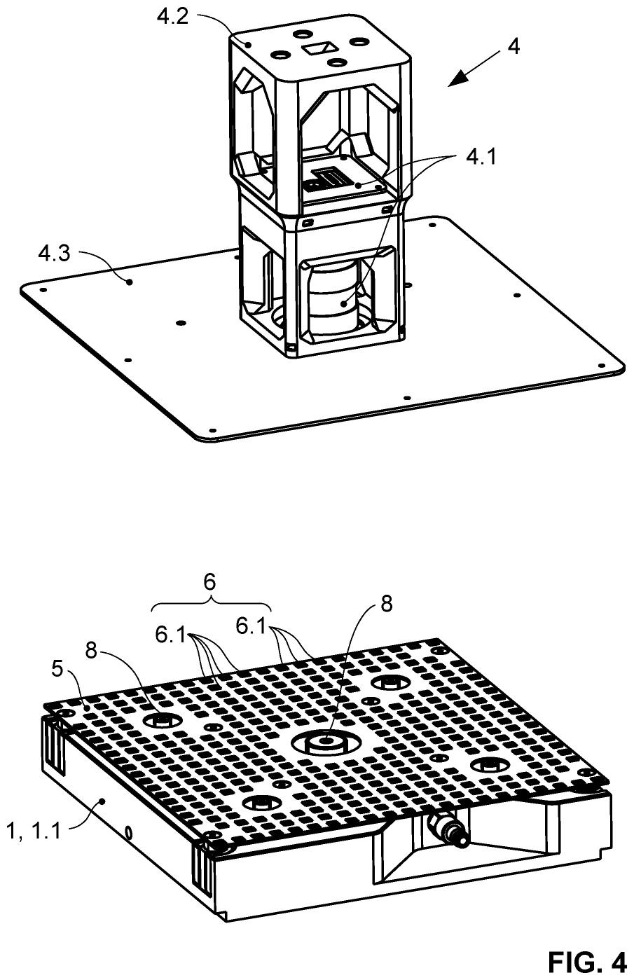

The calibration system according to FIG. 4 corresponds to that according to FIG. 3, but additionally shows the calibration pattern 6 applied onto the visible side of the calibration plate 5 by means of the laser of the additive manufacturing device, consisting of the individual pattern elements 6.1 arranged periodically in rows and columns.

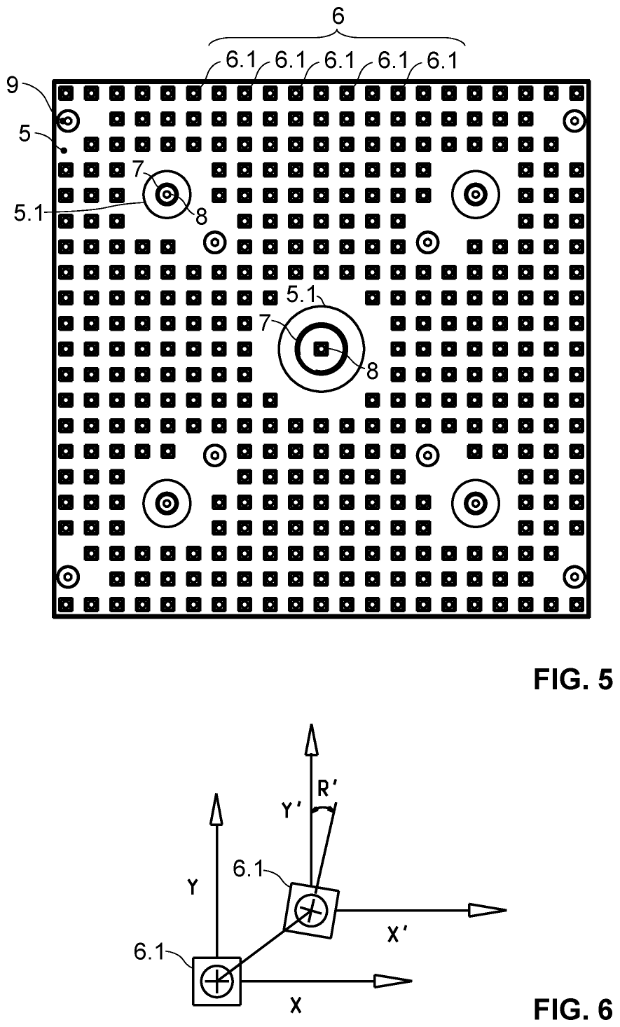

FIG. 5 shows a top view of the visible side of the calibration plate 5 shown in FIG. 4. The image created as part of the calibration process corresponds to the illustration in FIG. 5. Using this image, the actual position parameters for each of the two-dimensional pattern elements 6.1 are captured and processed by the evaluation unit.

FIG. 6 illustrates the target-actual comparison of the target position parameters and the actual position parameters using one of the pattern elements 6.1 in the coordinate system. The target position parameters of the two-dimensional pattern element 6.1 are the two predetermined target position coordinates X, Y and the target angular position in the two-dimensional plane, wherein the pattern element 6.1 has no rotation according to the predetermination, i.e. always has a target angular position of 0°. The actual position parameters determined photographically are the two measured actual position coordinates X′, Y′ and the measured angular position deviation R′ of the pattern element 6.1.

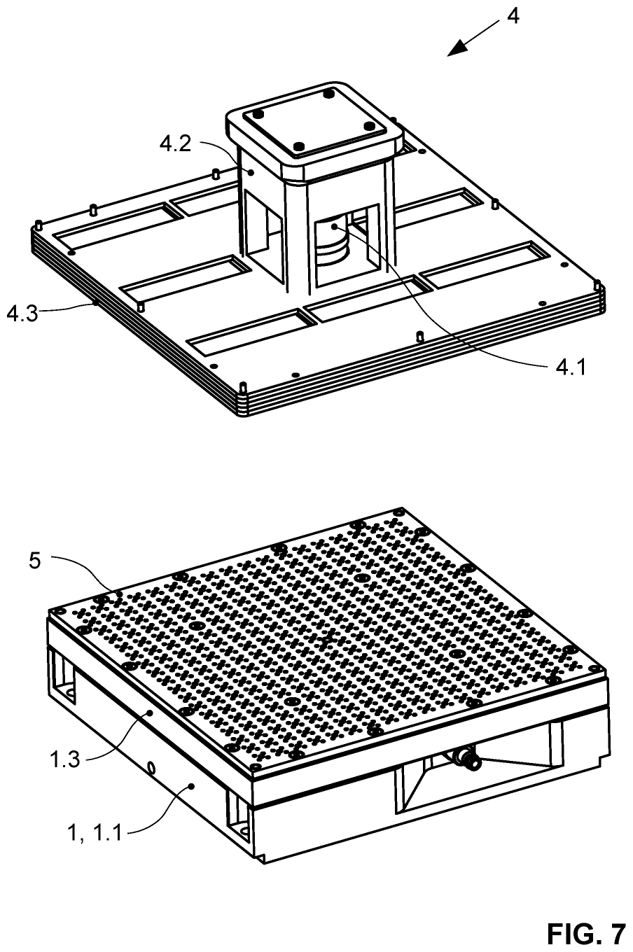

FIGS. 7 to 10 show a second embodiment of the calibration system for calibrating the building platform system 1.

The calibration platform 1.3 with the calibration plate 5 attached to it is mounted on the machine interface unit 1.1 (see FIG. 7) for calibrating the same. The optical module 4 located above comprises the optical detection unit 4.1, again a camera (the lens of which is visible in FIG. 7), the optical holder 4.2 and a plate-shaped cover.

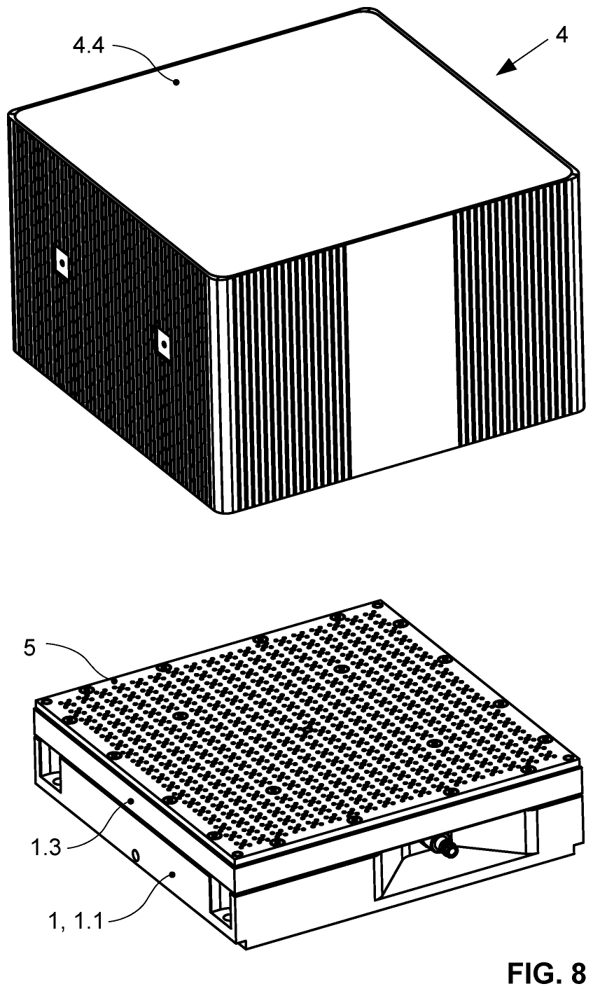

This cover is a sandwich structure made up of the downwards closing support plate 4.3, light-emitting diode panels and diffuser plates. FIG. 8 shows, in a representation corresponding to FIG. 7, a housing 4.4 of the optics module 4, by means of which the optical detection unit 4.1, the optics holder 4.2 and the plate-shaped cover are housed or shielded.

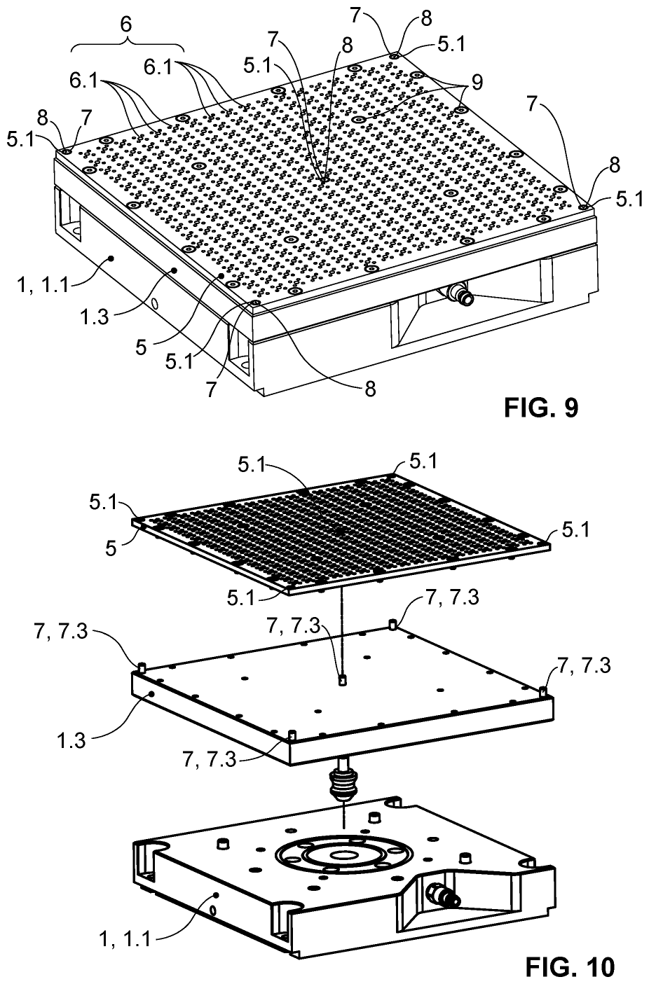

The detailed representation of the machine interface unit 1.1, the calibration platform 1.3 and the calibration plate 5 attached thereto according to the second embodiment of the calibration system can be seen in FIGS. 9 and 10.

The calibration pattern 6 applied onto the visible side of the calibration plate 5 by means of the laser of the additive manufacturing device, consisting of the individual pattern elements 6.1 arranged periodically in rows and columns according to FIG. 9, differs with regard to the design of the pattern elements 6.1 compared to the first embodiment of the calibration system according to FIG. 4.

The calibration plate 5, which is fixed to the calibration platform 1.3 by means of the fastening screws 9, has five reference mark recesses 5.1, which allow the optical detection unit 4.1 to view the reference markings 8 arranged centrally on the front sides of the reference mark carriers 7.

According to the second embodiment, the reference mark carriers 7 are designed as calibration pins 7.3, which are permanently installed on the calibration platform 1.3 (see FIG. 10). The calibration plate 5 has a thickness that corresponds to the height of the calibration pins 7.3, so that the reference markings 8 are in the same plane as the visible surface of the calibration plate 5.

As can be seen from FIG. 10, the calibration platform 1.3 can be fixed in position on the machine interface unit 1.1 by means of a zero-point clamping system guided by dowel pins.

### LIST OF REFERENCE NUMERALS

1 building platform system
1.1 machine interface unit
1.2 building platform
1.3 calibration platform
2 building space
3 component
3.1 basic body
3.2 build up body
4 optics module
4.1 optical detection unit
4.2 optics holder
4.3 support plate
4.4 housing
5 calibration plate
5.1 reference mark recesses
6 calibration pattern
6.1 pattern element
7 reference mark carriers
7.1 calibration dowel pin
7.2 hemispherical element
7.3 calibration pin
8 reference marking
9 fastening screws
10 spacer
X, Y predetermined target position coordinates
X′, Y′ measured actual position coordinates
R′ measured angular position deviation

1. A calibration system for calibrating a building platform system arranged in a building space of an additive manufacturing device, wherein the additive manufacturing device has a controllable laser for consolidating material during additive manufacturing on the building platform system, and wherein the calibration system comprises a calibration plate fixable on the building platform system and an optics module, characterized in that
the calibration plate consists of a predetermined base material, the calibration plate having a visible surface on one of its two flat plate sides, which is provided with a surface layer that contrasts in color with the base material, and
the optics module comprises an optical detection unit, an optics holder and a support plate for covering the building space of the additive manufacturing device, wherein the optical detection unit is fastened by means of the optics holder to the support plate in the region of a light passage recess in the support plate for optical image capture of the calibration plate fixed on the building platform system, and wherein lighting means for illuminating the building space are attached to the support plate) on the building space side.

2. The calibration system according to claim 1, characterized in that the surface layer on the visible side of the calibration plate is an oxidic conversion layer made of the base material of the calibration plate.

3. Calibration The calibration system according to claim 2, characterized in that the calibration plate consists of a steel material and wherein the surface layer on the visible side of the calibration plate is a burnished layer.

4. The calibration system according to claim 1, characterized in that the lighting means attached to the support plate on the building space side are uniformly distributed light-emitting diodes.

5. The calibration system according to claim 1, characterized in that the optics module has one or more sensors, wherein at least one of the sensors is a distance sensor for detecting the distance of the calibration plate fixed on the building platform system to the optical detection unit attached to the building space.

6. The calibration system according to claim 1, characterized in that it comprises one or more reference mark carriers, each with a reference marking, wherein the reference mark carriers can be fixed in a precise position on the building platform system, and wherein the calibration plate has reference mark recesses which, when the calibration plate is fastened to the building platform system, enable the optical detection unit to view the reference markings of the reference mark carriers fixed to the building platform system.

7. The calibration system according to claim 6, characterized in that the calibration system has a calibration platform for fixing the calibration plate to the building platform system, wherein the reference mark carriers are installed in a precisely positioned manner on the calibration platform.

8. A calibration method for calibrating a building platform system arranged in a building space of an additive manufacturing device, wherein the additive manufacturing device has a controllable laser for consolidating material during additive manufacturing on the building platform system and wherein
the position of the building platform system and objects mounted thereon in the building space are defined by building space coordinates within a building space coordinate system, and
by means of an evaluation unit, correction values for the building space coordinates are determined on the basis of a target-actual comparison of predetermined target position parameters and captured actual position parameters of two-dimensional pattern elements of a calibration pattern generated by means of the laser in relation to one or more reference markings attached to the building platform system,
characterized in that the calibration method is carried out by means of the evaluation unit and a calibration system according to claim 6 with the following method steps:
fixing the calibration plate and the reference mark carrier or carriers having the reference markings to the building platform system arranged in the building space of the additive manufacturing device,
applying a calibration pattern extending over the visible surface of the calibration plate to the calibration plate by means of the controllable laser of the additive manufacturing device by locally removing the surface layer on the visible surface of the calibration plate,
positioning the building platform system with the calibration plate at a predetermined working distance from the optical detection unit in the building space,
attaching the optics module to the building space and covering the building space with the support plate of the optics module,
taking an image of the calibration plate by means of the optical detection unit, and
evaluating the image of the calibration plate and determining the correction values of the building space coordinates using the evaluation unit.

9. The calibration method according to claim 8, characterized in that the calibration pattern applied in by means of the laser in the surface layer on the visible surface of the calibration plate has a plurality of individual pattern elements with identical two-dimensional geometry, wherein the pattern elements are arranged at a distance from one another in rows and columns on the visible surface of the calibration plate and wherein each of the pattern elements comprises
a fourfold rotational symmetry,
at least two line segments perpendicular to each other and
a single circle or point element.

10. The calibration method according to claim 9, characterized in that each of the pattern elements has a minimum distance from each of its adjacent pattern elements within the same row or column, which minimum distance is greater than or equal to the extension of the pattern element.

11. Calibration The calibration method according to claim 8, characterized in that the laser is operated with process parameters typical for additive manufacturing in the additive manufacturing device when introducing the calibration pattern into the calibration plate.
